(19) United States
(12) Patent Application Publication
(10) Pub. No.: US 2016/0048294 A1
(43) Pub. Date: Feb. 18, 2016

(54) Direct Access Application Representations

(71) Applicant: Microsoft Technology Licensing, LLC, Redmond, WA (US)

(72) Inventors: Nora I. Micheva, Seattle, WA (US); Matthew G. Hidinger, Seattle, WA (US); Megan L. Tedesco, Sammamish, WA (US); James David Peter Drage, Seattle, WA (US); Sean L. Flynn, North Bend, WA (US); Mustafa M. Almaasrawi, Redmond, WA (US); John P. Aronson, WA (US); Jeff G. Arnold, Sammamish, WA (US); Aaron Naoyoshi Sheung Yan Woo, Bellevue, WA (US); Jaclyn C. Knapp, Redmond, WA (US); Andrea Michelle Simons, Kirkland, WA (US)

(73) Assignee: Microsoft Technology Licensing, LLC, Redmond, WA (US)

(21) Appl. No.: 14/460,610

(22) Filed: Aug. 15, 2014

(51) Int. Cl. G06F 3/0481; G06F 3/0482

(52) U.S. Cl. CPC G06F 3/04817; G06F 3/0482

(57) ABSTRACT

Direct access application representation techniques are described. In one or more implementations, a user interface is exposed by an operating system of a computing device. The user interface includes a concurrent display of a plurality of representations of applications that are selectable by a user to launch respective applications, at least one of the plurality of representations includes a concurrent display of a plurality of user-selectable targets for a respective application, and each of the plurality of user-selectable targets is selectable by a user to obtain direct access to a respective one of a plurality of application functionality of the respective application. Responsive to an input indicative of user selection of one of the plurality of user-selectable targets of the at least one representation of the respective application, the direct access is provided to the respective one of the plurality of application functionality of the respective application.

### BACKGROUND

Computing devices may employ a variety of applications to access an ever increasing variety of functionality. As a computing device may include tens and even hundreds of applications, techniques have been developed to manage user interaction with the applications, such as to select applications for execution by the computing device.

Some conventional techniques that were utilized to manage this interaction utilized icons to represent the application. Therefore, a user wanting to interact with the application selected the application for launching, such as from a root level of a file management system of the computing device. The selection then resulted in a modal transfer away from a user interface that included the icons (e.g., the root level) to a user interface of the application itself such that a user may view content related to the application.

In an effort to avoid this modal navigation, additional techniques have been developed that involve the use of “widgets.” Widgets are typically configured as standalone applications themselves, however, that are added separately for inclusion as part of a user interface to provide additional information. A user, for instance, may install a weather application and also a weather widget separately to use the weather widget to access user specified weather information at the root level of the file management system separately from the weather application. Thus, this technique may also involve significant additional user interaction in locating and configuring the separate applications which may be frustrating to the user and thus generally avoided.

### SUMMARY

Direct access application representation techniques are described. In one or more implementations, a user interface is exposed by an operating system of a computing device. The user interface includes a concurrent display of a plurality of representations of applications that are selectable by a user to launch respective applications, at least one of the plurality of representations includes a concurrent display of a plurality of user-selectable targets for a respective application, and each of the plurality of user-selectable targets is selectable by a user to obtain direct access to a respective one of a plurality of application functionality of the respective application. Responsive to an input indicative of user selection of one of the plurality of user-selectable targets of the at least one representation of the respective application, the direct access is provided to the respective one of the plurality of application functionality of the respective application.

In one or more implementations, a computing device includes one or more modules implemented at least partially in hardware. The one or more modules are configured to output a user interface for display. The user interface includes a concurrent display of a plurality of representations of applications that are selectable by a user to launch respective applications, at least one of the plurality of representations includes a concurrent display of a plurality of user-selectable targets, and each of the plurality of user-selectable targets is selectable by a user to obtain direct access to a respective one of a plurality of application functionality of the respective application represented by the at least one representation.

In one or more implementations, a computing device includes a processing system and memory having instructions that are executable by the processing system to include an application having a plurality of entry points that are different, one from another, to access different parts of the application and an operating system that is configured to output a representation of the application that is selectable to launch the application. The representation includes a plurality of user-selectable targets that are displayable concurrently, each of the plurality of user-selectable targets selectable by a user to obtain direct access to a respective one of the plurality of entry points of the application.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an environment in an example implementation that is configured to perform direct access application representation techniques described herein.

FIG. 2 depicts an example implementation showing a representation of an application of FIG. 1 as having a plurality of user-selectable targets.

FIG. 3 depicts an example implementation showing direct access of user-selectable targets of a representation of an application in FIG. 1 to application functionality configured as entry points of the application.

FIG. 4 depicts an example implementation showing direct access of user-selectable targets of a representation of an application in FIG. 1 to application functionality configured as actions performed by the application.

FIG. 5 depicts an example implementation showing examples of configurations of the representation of FIG. 4 that includes a plurality of user-selectable targets.

FIG. 6 is an illustration of a flow chart in an example implementation in which a user interface is exposed that is configured to include a representation that provides direct access to application functionality via user-selectable targets included in the representation.

FIG. 7 illustrates various components of an example device that can be implemented as any type of computing device as described with reference to FIGS. 1-6 to implement embodiments of the techniques described herein.

### DETAILED DESCRIPTION

Overview

Conventional techniques utilized to interact with an application typically involved selection of a representation of the application to launch the application to then gain access to functionality of the application. Although widgets were introduced to correct some of these shortcomings, widgets are configured as standalone applications and thus require separate installation apart from the associated application, e.g., a weather application and a weather widget.

Direct access application representation techniques are described. In one or more implementations, an application representation (e.g., an icon, tile, or so on) is configured to launch execution of an application. The application representation also includes a plurality of user-selectable targets that are displayable concurrently as part of the representation.

For example, the representation may be configured as a tile that includes a plurality of portions (e.g., sub-tiles) that are user-selectable. The user-selectable targets are configured such that selection by a user causes access to corresponding functionality of the application and in this way may provide a “deep link” to various functionality of the application. The tile, for instance, may include a user-selectable target to navigate to a root level (e.g., welcome screen) of the application, e.g., a start screen of a weather application. Other user-selectable targets may be utilized to access other application functionality, such as weather at different geographic locations. In this way, a user may directly access different parts of an application directly from the representation of the application that is usable to launch the application. A variety of other examples are also contemplated, further discussion of which may be found in relation to the following sections.

In the following discussion, an example environment is first described that may employ the direct access application representation techniques described herein. Example procedures are then described which may be performed in the example environment as well as other environments. Consequently, performance of the example procedures is not limited to the example environment and the example environment is not limited to performance of the example procedures.

Example Environment

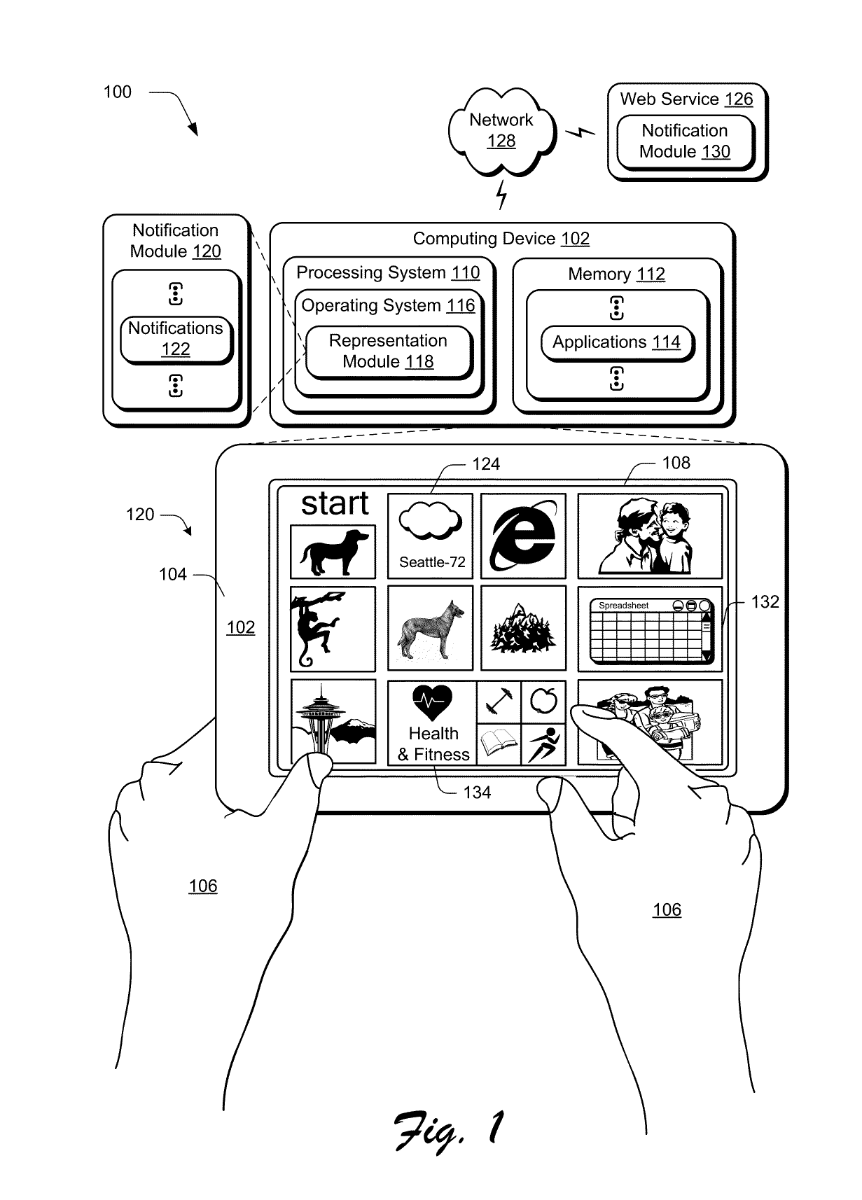

FIG. 1 is an illustration of an environment 100 in an example implementation that is operable to employ the direct access application representation techniques described herein. The illustrated environment 100 includes an example of a computing device 102, which is illustrated as a mobile computing device (e.g., tablet or mobile phone) having a housing 104 that is configured to be held by one or more hands 106 of a user. A variety of other configurations of the computing device 102 are also contemplated.

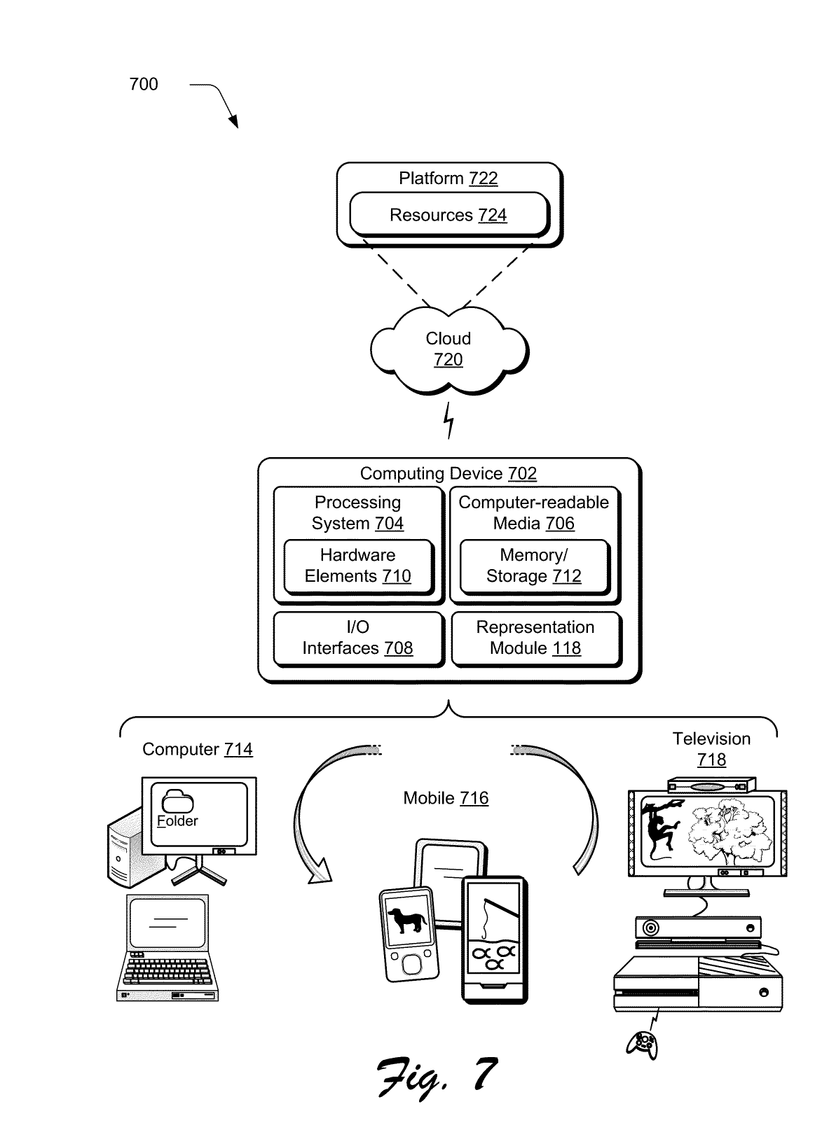

For example, the computing device 102 may be configured as a traditional computer (e.g., a desktop personal computer, laptop computer, and so on), a mobile station, an entertainment appliance, a wireless phone, a tablet, a netbook, and so forth as further described in relation to FIG. 7. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is also illustrated as including a display device 108, a processing system 110, and an example of computer-readable storage media, which in this instance is memory 112. The memory 112 is configured to maintain applications 114 that are executable by the processing system 110 to perform one or more operations.

The processing system 110 is not limited by the materials from which it is formed or the processing mechanisms employed therein. For example, the processing system 110 may be comprised of semiconductor(s) and/or transistors (e.g., electronic integrated circuits (ICs)), such as a system on a chip, processors, central processing units, processing cores, functional blocks, and so on. In such a context, executable instructions may be electronically-executable instructions. Alternatively, the mechanisms of or for processing system 110, and thus of or for a computing device, may include, but are not limited to, quantum computing, optical computing, mechanical computing (e.g., using nanotechnology), and so forth. Additionally, although a single memory 112 is shown, a wide variety of types and combinations of memory may be employed, such as random access memory (RAM), hard disk memory, removable medium memory, and other types of computer-readable media.

The computing device 102 is further illustrated as including an operating system 116. The operating system 116 is configured to abstract underlying functionality of the computing device 102 to applications 114 that are executable on the computing device 102. For example, the operating system 116 may abstract the processing system 110, memory 112, network, input/output, and/or display functionality of the display device 108, and so on such that the applications 114 may be written without knowing “how” this underlying functionality is implemented. The application 114, for instance, may provide data to the operating system 116 to be rendered and displayed by the display device 104 without understanding how this rendering will be performed. The operating system 116 may also represent a variety of other functionality, such as to manage a file system and user interface that is navigable by a user of the computing device 102, such as to manage access to applications 114 in a graphical user interface as further described below.

The operating system 116 may also represent a variety of other functionality, such as to manage a file system and a user interface that is navigable by a user of the computing device 102. An example of this is illustrated as a representation module 118 that is representative of functionality to generate and manage representations of applications 114.

The representation module 118, for instance, may generate a variety of representations for the plurality of the applications 114 that may be configured in a variety of ways, such as icon, tiles, textual descriptions, and so on. The representations may also be utilized in a variety of ways, such as at a root level of a hierarchical file structure, e.g., each of the other levels are “beneath” the root level in the hierarchy. An example of this is illustrated as an application launcher (e.g., start screen) that is displayed in a user interface on the display device 108 in FIG. 1. The representations shown in the illustrated example are selectable to launch a corresponding one of applications 114 for execution by the processing system 110 of the computing device 102. In this way, a user may readily navigate through a file structure and initiate execution of applications 114 of interest.

Thus, the representation module 118 is representative of functionality to manage representations of applications 114 (e.g., tiles, icons, and so on) and content consumable by the applications 114. In some instances, the representations may include notifications that may be displayed as part of the representations without launching the represented applications 114, e.g., as text or graphics within the display of the representation. This functionality is illustrated as a notification module 120 that is configured to manage notifications 122 for inclusion as part of the representations.

For example, a representation 124 of a weather application is illustrated as including a notification that indicates a name and current weather conditions, e.g., “72° ” and an illustration of a cloud. In this way, a user may readily view information relating to applications 114 without having to launch and navigate through each of the applications 114. In one or more implementations, the notifications 122 may be managed without executing the corresponding applications 114. For example, the notification module 120 may receive the notifications 122 from a variety of different sources, such as from software (e.g., other applications executed by the computing device 102), from a web service 126 via a network 128, and so on.

This may be performed responsive to registration of the applications 114 with the notification module 120 to specify from where and how notifications are to be received. The notification module 120 may then manage how the notifications 122 are displayed as part of the representations without executing the applications 114. This may be used to improve battery life and performance of the computing device 102 by not executing each of the applications 114 to output respective notifications 122.

Although this discussion described incorporation of the notification module 120 at the client, functionality of the notification module 120 may be implemented in a variety of ways. For example, functionality of a notification module 120 may be incorporated by the web service 126 in whole or in part. The notification module 130 of the web service 126, for instance, may process notifications received from other web services and manage the notifications for distribution to the computing device 102 over the network 128, e.g., through registration of the applications 114 with the notification module 120, 130 such that the notifications 122 may be output as part of the representations without execution the represented applications 114.

Representations that are generated by the representation module 118 of the operating system 116 on behalf of the applications 114 may be configured in a variety of ways. As illustrated, for instance, the representations 124, 132, 134 may be configured according to a variety of different sizes. The representation 124 may be configured for output of notifications 122 as previously described, a representation 132 may be configured to access specific content (e.g., a particular spreadsheet in this example), and so on.

Additionally, a representation 134 may also be configured to support direct access to a plurality of different application functionality of the represented application 114, e.g., a health & fitness application in this example. In this way, a user may gain direct access to different functionality of the application 114 directly from the representation of the application 114 used to launch the application 114, an example of which is described in greater detail below and shown in a corresponding figure.

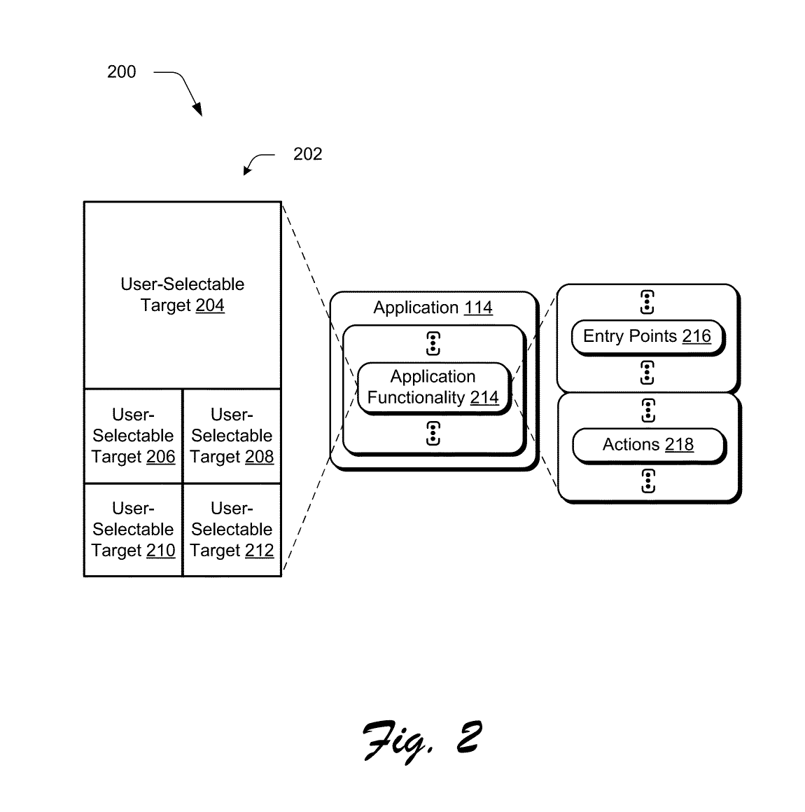

FIG. 2 depicts an example implementation 200 showing a representation of an application 114 of FIG. 1 as having a plurality of user-selectable targets. In this example, a representation 202 is illustrated that corresponds to a single application 114, i.e., that represents that application 114 solely in a file management structure of the computing device 102 of FIG. 1. The representation includes a plurality of user-selectable targets 204, 206, 208, 210, 212, each of which corresponds to a different one of a plurality of application functionality 214. In this way, a user may select a desired one of the plurality of user-selectable targets 204-212 to gain direct access to a respective one of a plurality of different application functionality 214 of the application 114.

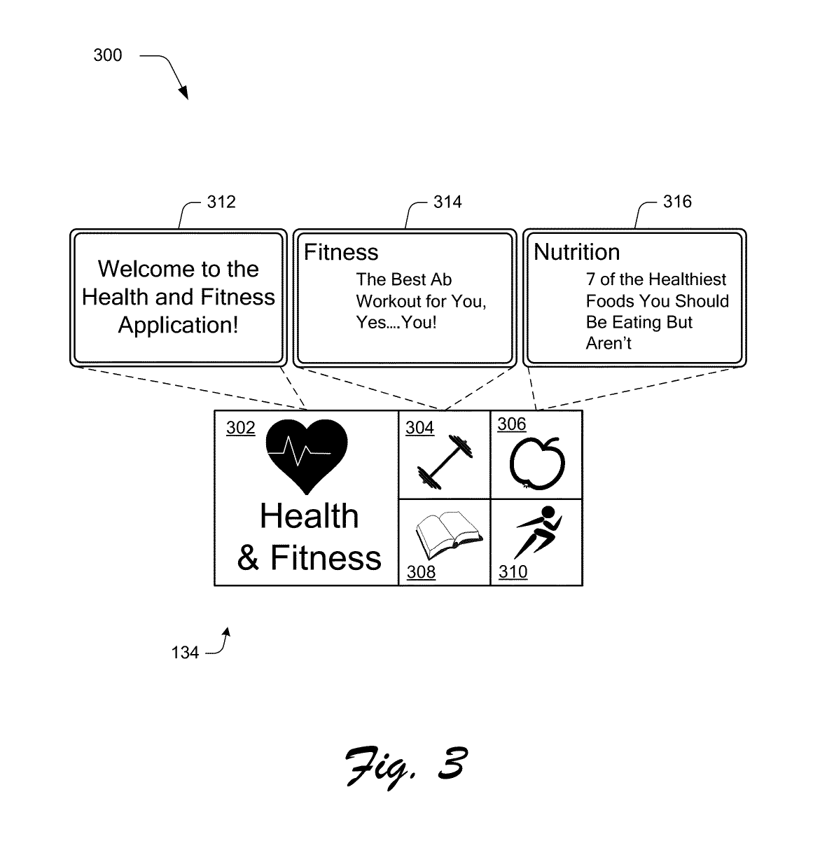

The application functionality 214 may be configured in a variety of ways. For example, the application functionality 214 may correspond to a plurality of entry points 216 of the application 114. The application 114, for instance, may include a root level entry point such as a welcome screen as well as different pages, tabs, chapters, and other sections may also be utilized as entry points 216. In this way, the user-selectable targets 204 may provide direct access to different parts of the application through use of the entry points 216 in a modal manner that causes output of a relevant user interface of the application 114 through execution of the application 114. Further discussion of user-selectable targets 204-212 and entry points 216 may be found in relation to FIG. 3.

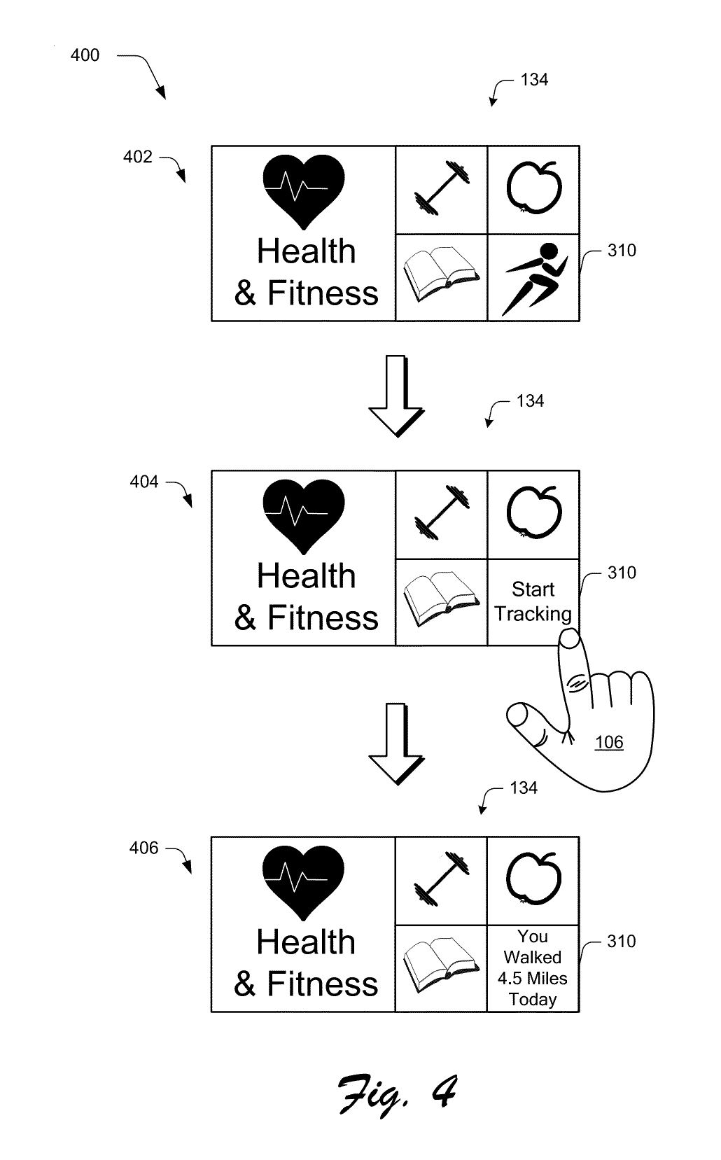

In another example, the application functionality 214 may be configured as actions 218 that are associated with the application 114 that are directly accessible via the user-selectable targets 204-212. A user, for instance, may select one of the user-selectable targets 204-212 to gain access to actions 218 that may be performed by the application 114 in association with the representation 202 in a non-modal manner. For example, a user may select a user-selectable target of the representation 202 to initiate execution of an action 218 by the application 114 without navigating away from a display of the representation 202. Thus, application developers may configure actions 218 that may be directly accessed via the application 202 in a non-modal manner, further discussion of which may be found in relation to FIG. 4.

FIG. 3 depicts an example implementation 300 showing direct access of user-selectable targets of the representation 134 of an application in FIG. 1 to application functionality 214 configured as entry points 216. In this example, the representation 134 corresponds to a single application, which is a health and fitness application in this example although other applications are also contemplated without departing form the spirit and scope thereof.

The representation 134 in this example includes a plurality of user-selectable targets 302, 304, 306, 308, 310, 312. As previously described, each of the user-selectable targets 302-312 is selectable by a user to directly access corresponding application functionality 214 of the represented application.

For example, user-selectable targets 302, 304, 306 in this example are user selectable to access different ones of a plurality of entry points 216 of the application 114. User-selectable target 302, for instance, is selectable to access an entry point 312 of the application 114 at a root level of the application 114, e.g., a welcome screen or other user interface level that is arranged at a root level of a hierarchy of a user interface of the application. Thus, selection of this user-selectable target 302 provides directs access to a root level of the application 114 represented by the representation 134 by launching the application 114 and causing navigation to that access point automatically and without further user intervention.

User-selectable targets 304, 306, provide direct access to different entry points 314, 316 of the application 114 than the root level access point 312 corresponding to user-selectable target 302. User-selectable target 304, for instance, is selectable to provide direct access to an entry point 314 of the application 114 relating to fitness. Likewise, user-selectable target 306 is selectable to provide direct access to an entry point 316 of the application 114 relating to nutrition.

Thus, the user-selectable targets 302-306 may be selected to launch execution of the application 114 (if not already executed) and navigate to corresponding application functionality 214, which in this case are entry points 312-316 in a modal manner that causes navigation away from display of the representation 218 to output of a user interface at those entry points 312, 314, 316, e.g., through use of a window, a full-screen immersive view, and so on. Non-modal direct access techniques are also contemplated, further discussion of which may be found in the following and shown in a corresponding figure.

FIG. 4 depicts an example implementation 400 showing direct access of user-selectable targets of the representation 134 of an application 114 in FIG. 1 to application functionality 214 configured as actions 218. This example is illustrated using first, second, and third stages 402, 404, 406. At the first stage 402, a representation 134 is displayed in a user interface that includes a plurality of user-selectable targets as previously described.

At the second stage 404, a finger of a user's hand 106 is illustrated as selecting a user-selectable target 310. In response, an action 218 is initiated that corresponding to the user-selectable target 310, such as to initiate tracking of an amount a user runs by the health and fitness application. As illustrated, this initiation of application functionality is performed in this instance through non-modal interaction with the user-selectable target 310 of the representation. Thus, a user may initiate execution of the representation application and corresponding action through direct access provided by the user-selectable target 310 without navigating away from the representation 134.

At the third stage 406, the representation 134 outputs notifications generated by the application 114 as part of the user-selectable portion 310, which in this instance is the amount of distance a user has run. In one or more implementations, the representation 134 may also employ notifications 112 of the notification module 120 as part of the user-selectable target 310, such that the application 114 that is represented is not output, e.g., to track distance by the operating system 116 and associated functionality (e.g., GPS hardware) without executing the represented application. Thus, non-modal interaction and actions 218 may also be utilized by the representation 134 of the application 114 in a variety of ways. The representation 134 may be configured in a variety of ways, examples of which are described in the following and shown in corresponding figure.

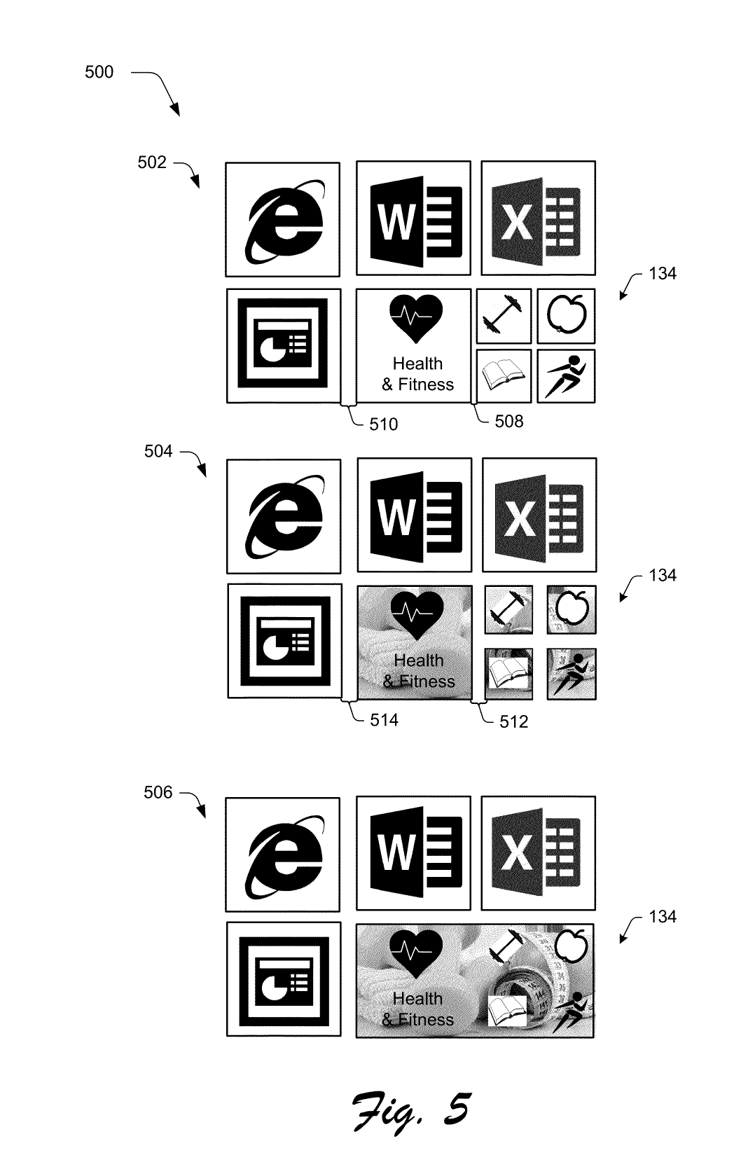

FIG. 5 depicts an example implementation 500 showing examples 502, 504, 506 of configurations of the representation 134 that includes a plurality of user-selectable targets. In the first example 502, the representation 134 is configured to include user-selectable targets that are separated by gutters 508, one to another, that are smaller than gutter 510 used to separate representations of individual applications from each other. Thus, in this example the user-selectable targets are divided from each other but not divided so much that the targets look like separate tiles.

In the second example 504, sub-tile user selectable targets of the representation 134 are separated by the same size gutters 512 as gutters 514 used to separate representations of individual applications from each other. A visual characteristic is utilized in this example to indicate that the individual user-selectable targets are part of a single representation and yet differentiate that representation 134 from representations of other applications. In the illustrated example, for instance, a common background is used (e.g., a single image used across the sub-tiles) but other examples are also contemplated, such as a common color, shading, border treatment, and so forth.

In the third example 506, the representation 134 is configured as having a single background with icons used to indicate user-selectable targets. By overlaying the user-selectable targets over a bigger canvas of the representation 134, the user-selectable targets look like separate targets while at the same time indicate inclusion as part of the representation. A variety of other examples and arrangements are also contemplated without departing from the spirit and scope thereof, including different arrangement (e.g., vertical), shapes, relative sizes, and so forth. Further discussion of the direct access application representation techniques may be found in relation to the following procedure.

Example Procedures

The following discussion describes direct access application representation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the example environment described above.

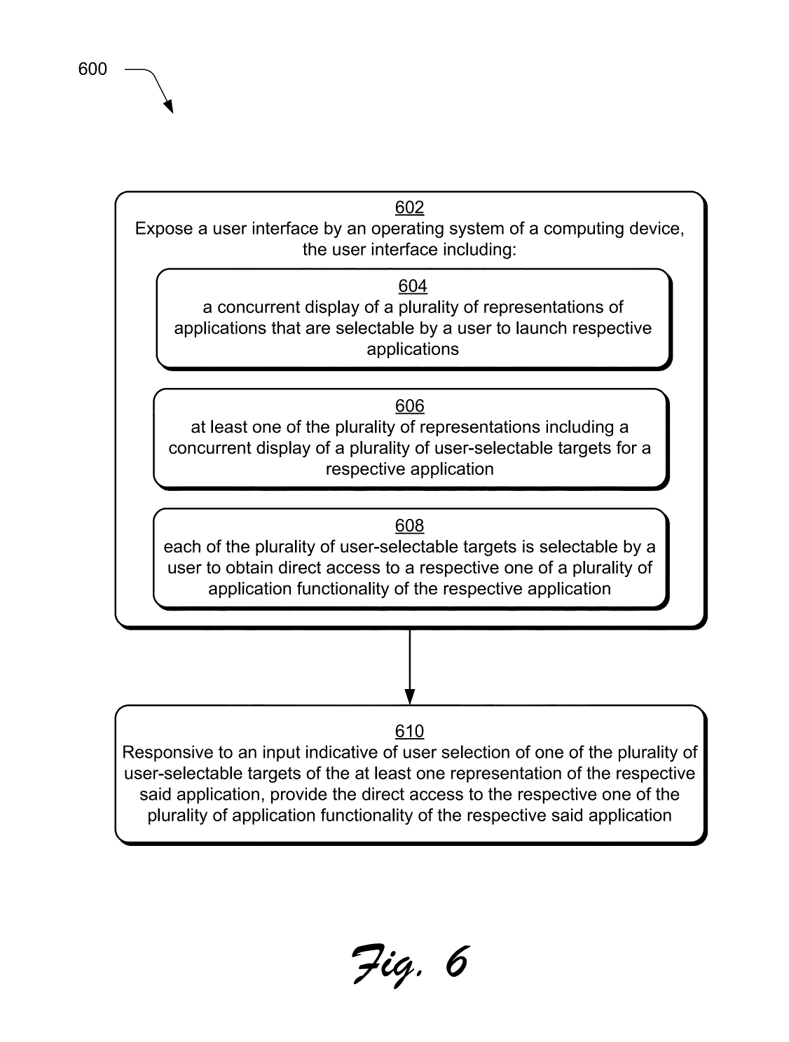

FIG. 6 depicts a procedure 600 in an example implementation in which a user interface is exposed that is configured to include a representation that provides direct access to application functionality via user-selectable targets included in the representation. A user interface is exposed by an operating system of a computing device (block 602). The user interface includes a concurrent display of a plurality of representations of applications that are selectable by a user to launch respective applications (block 604). As shown in FIG. 1, for instance, an application launcher such as a start screen, start menu, and so on may include representations (e.g., tiles in this instance but others are also contemplated) that are selectable to launch the represented application 114 for execution on the processing system 110.

The user interface includes at least one of the plurality of representations including a concurrent display of a plurality of user-selectable targets for a respective application (block 606) in which each of the plurality of user-selectable targets is selectable by a user to obtain direct access to a respective one of a plurality of application functionality of the respective application (block 608). Continuing with the previous example, representation 134 includes a plurality of user selectable portions 302-310, which may be utilized to access application functionality 214 such as entry points 216, actions 218 (e.g., modal or non-modal), and so forth.

Responsive to an input indicative of user selection of one of the plurality of user-selectable targets of the at least one representation of the respective application, the direct access is provided to the respective one of the plurality of application functionality of the respective application (block 610). As shown in FIG. 3, for instance, selection of user-selectable targets 312-316 may be utilized to direct access corresponding entry points 312-316 of a single application from the representation 134. Like, selection of user-selectable target 310 may be utilized to direct access an action that is performable by the represented application. A variety of other examples are also contemplated without departing from the spirit and scope thereof.

Example System and Device

FIG. 7 illustrates an example system generally at 700 that includes an example computing device 702 that is representative of one or more computing systems and/or devices that may implement the various techniques described herein, which is illustrated through inclusion of the representation module 118. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 702 may assume a variety of different configurations, such as for computer 714, mobile 716, and television 718 uses. Each of these configurations includes devices that may have generally different constructs and capabilities, and thus the computing device 702 may be configured according to one or more of the different device classes. For instance, the computing device 702 may be implemented as the computer 714 class of a device that includes a personal computer, desktop computer, a multi-screen computer, laptop computer, netbook, and so on.

The computing device 702 may also be implemented as the mobile 716 class of device that includes mobile devices, such as a mobile phone, portable music player, portable gaming device, a tablet computer, a multi-screen computer, and so on. The computing device 702 may also be implemented as the television 718 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This functionality may also be implemented all or in part through use of a distributed system, such as over a “cloud” 720 via a platform 722 as described below.

The cloud 720 includes and/or is representative of a platform 722 for resources 724. The platform 722 abstracts underlying functionality of hardware (e.g., servers) and software resources of the cloud 720. The resources 724 may include applications and/or data that can be utilized while computer processing is executed on servers that are remote from the computing device 702. Resources 724 can also include services provided over the Internet and/or through a subscriber network, such as a cellular or Wi-Fi network.

The platform 722 may abstract resources and functions to connect the computing device 702 with other computing devices. The platform 722 may also serve to abstract scaling of resources to provide a corresponding level of scale to encountered demand for the resources 724 that are implemented via the platform 722. Accordingly, in an interconnected device embodiment, implementation of functionality described herein may be distributed throughout the system 700. For example, the functionality may be implemented in part on the computing device 702 as well as via the platform 722 that abstracts the functionality of the cloud 720.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
exposing a user interface by an operating system of a computing device, the user interface including:
a concurrent display of a plurality of representations of applications that are selectable by a user to launch respective said applications;
at least one of the plurality of representations including a concurrent display of a plurality of user-selectable targets for a respective said application; and
each of the plurality of user-selectable targets is selectable by a user to obtain direct access to a respective one of a plurality of application functionality of the respective said application; and
responsive to an input indicative of user selection of one of the plurality of user-selectable targets of the at least one representation of the respective said application, providing the direct access to the respective one of the plurality of application functionality of the respective said application.

2. A method as described in claim 1, wherein the plurality of application functionality includes a plurality of different entry points of the respective said application that are accessible via respective ones of the plurality of user-selectable targets.

3. A method as described in claim 2, wherein at least one of the entry points corresponds to a root level of the respective said application and at least another one of the entry points does not correspond to the root level of the respective said application.

4. A method as described in claim 2, wherein the user-selectable targets that correspond to entry points are configured to cause the respective said application to be launched and accessed at the entry points.

5. A method as described in claim 1, wherein the plurality of application functionality includes a plurality of actions associated with the respective said application.

6. A method as described in claim 5, wherein at least one of the actions is non-modal in relation to display of the at least one representation.

7. A method as described in claim 1, wherein the at least one representation is also configured to output notifications within the representation without executing the represented application.

8. A method as described in claim 1, wherein the plurality of representations are tiles or icons.

9. A method as described in claim 1, wherein the plurality of user-selectable targets are selectable via a gesture or through use of a cursor control device.

10. A method as described in claim 1, wherein the plurality of user-selectable targets correspond to different portions of the at least one representation of the respective said application.

11. A method as described in claim 1, wherein the plurality of user-selectable targets have a visual characteristic that is common and indicative that the plurality of user-selectable targets each correspond to the respective said application and differentiate the plurality of user-selectable targets from other ones of the plurality of representations.

12. A method as described in claim 11, wherein the visual characteristic is a shared background or color.

13. A method as described in claim 1, wherein the plurality of user-selectable targets are visually distinguishable from each other.

14. A computing device comprising:
one or more modules implemented at least partially in hardware, the one or more modules configured to output a user interface for display, the user interface including:
a concurrent display of a plurality of representations of applications that are selectable by a user to launch respective said applications;
at least one of the plurality of representations includes a concurrent display of a plurality of user-selectable targets; and
each of the plurality of user-selectable targets is selectable by a user to obtain direct access to a respective one of a plurality of application functionality of the respective said application represented by the at least one representation.

15. A computing device as described in claim 14, wherein the at least one representation is also configured to output notifications within the representation without executing the represented application.

16. A computing device as described in claim 14, wherein the plurality of application functionality includes a plurality of different entry points of the respective said application that are accessible via respective ones of the plurality of user-selectable targets.

17. A computing device as described in claim 14, wherein the plurality of application functionality includes a plurality of actions associated with the respective said application.

18. A computing device comprising:
a processing system; and
memory having instructions that are executable by the processing system to include:
an application having a plurality of entry points that are different, one from another, to access different parts of the application; and
an operating system configured to output a representation of the application that is selectable to launch the application, the representation including a plurality of user-selectable targets that are displayable concurrently, each of the plurality of user-selectable targets selectable by a user to obtain direct access to a respective one of the plurality of entry points of the application.

19. A computing device as described in claim 18, wherein the representation is also configured to output notifications within the representation without executing the application.

20. A computing device as described in claim 18, wherein at least one of the entry points corresponds to a root level of the respective said application and at least another one of the entry points does not correspond to the root level of the respective said application.
